(19) United States
(12) Patent Application Publication
(10) Pub. No.: US 2024/0317941 A1
(43) Pub. Date: Sep. 26, 2024

(54) ELEMENTAL SULFUR-ACRYLIC EMULSION

(71) Applicant: Khalifa University of Science and Technology, Abu Dhabi (AE)

(72) Inventors: Saeed M. ALHASSAN, Abu Dhabi (AE); Kishore Kumar JENA, Abu Dhabi (AE); Anjali GOYAL, Abu Dhabi (AE)

(21) Appl. No.: 18/269,414

(22) PCT Filed: Feb. 9, 2022
(86) PCT No.: PCT/IB2022/051173

§ 371 Date: Jun. 23, 2023

Related U.S. Application Data
(60) Provisional application No. 63/147,377, filed on Feb. 9, 2021.

(51) Int. Cl. C08G 75/02

(52) U.S. Cl. CPC C08G 75/02

(57) ABSTRACT

In general, embodiments of the present disclosure describe a method of sulfur polymerization including preparing a monomer solution. The monomer solution includes sulfur, at least one monomer selected from a vinyl-monomer group including styrene, n-butyl methyl acrylate, methyl methacrylate, acrylic acid, and mixtures thereof, one or more surfactants. The method includes preparing a reaction solution. The reaction solution includes water, combining the monomer solution with the reaction solution, agitating the reaction solution and the monomer solution, adding a free radical initiator, and increasing a reaction temperature.

### BACKGROUND

Large amounts of elemental sulfur (S₈) are generated as a waste byproduct from hydro desulfurization of crude petroleum feedstocks. Elemental sulfur consists of a cyclic molecule having the chemical formulation S₈ in its original form. Current industrial utilization of elemental sulfur is centered on sulfuric acid, agrochemicals, and vulcanization of rubber. Elemental sulfur is used primarily for sulfuric acid and ammonium phosphate fertilizers, where the rest of the excess sulfur is stored above ground to form sulfur towers.

Elemental sulfur is a brittle, intractable, crystalline solid having poor solid state mechanical properties, poor solution processing characteristics, and there is a limited slate of synthetic methodologies developed for it. Hence, there is a need for the production of new materials that offers significant environmental and public health benefits to mitigate the storage of excess sulfur in powder, or brick form.

Furthermore, sulfur can oxidize lithium when configured appropriately in an electrochemical cell and is known to be a high energy-density cathode material. The poor electrical and electrochemical properties of pure elemental sulfur, such as low cycle stability and poor conductivity, have limited the development of this technology. Hence, the design of novel polymer materials from elemental sulfur feedstocks would be beneficial in improving sustainability and energy practices. In particular, improved battery technology and materials that can extend cycle lifetimes while retaining reasonable charge capacity will significantly impact the energy and transportation sectors.

### SUMMARY

In general, embodiments of the present disclosure describe a method of sulfur polymerization including preparing a monomer solution. The monomer solution includes sulfur, at least one monomer selected from a vinyl-monomer group including styrene, n-butyl methyl acrylate, methyl methacrylate, acrylic acid, and mixtures thereof, one or more surfactants. The method includes preparing a reaction solution. The reaction solution includes water, combining the monomer solution with the reaction solution, agitating the reaction solution and the monomer solution, adding a free radical initiator, and increasing a reaction temperature.

Embodiments also include a polymeric composition comprising sulfur, and at least one emulsion monomer selected from a group comprising styrene, n-butyl methyl acrylate, methyl methacrylate, acrylic acid, and mixtures thereof. The sulfur is dispersed in a core-shell structure of the at least one emulsion monomer.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1A is a block diagram of an elemental sulfur-acrylic emulsion, according to one or more embodiments of the present disclosure.

FIG. 1B is a block diagram for a preparation of a monomer solution, according to one or more embodiments of the present disclosure.

FIG. 2 is a graphical depiction of a FTIR spectra of SBMA and S-SBMA polymerized emulsion in the range of 4000-400 cm⁻¹, according to one or more embodiments of the present disclosure.

FIG. 3 is a graphical depiction of XRD results of SBMA and S-SBMA emulsion samples in the range of 5-60°, according to one or more embodiments of the present disclosure.

FIG. 4 is a results chart of DLS particle size of SBMA and S-SBMA polymerized emulsion, according to one or more embodiments of the present disclosure.

FIGS. 5A-5B are graphical depictions of TGA and DTG results of SBMA and S-SBMA polymerized emulsion, according to one or more embodiments of the present disclosure.

FIGS. 6A-6B are graphical depictions of a DSC thermogram of SBMA and S-SBMA polymerized emulsion, according to one or more embodiments of the present disclosure.

FIGS. 7A-D are TEM and SEM images of SBMA and S-SBMA polymerized emulsion, according to one or more embodiments of the present disclosure.

FIGS. 8A-8D are TEM and SEM images of SBMA and S-SBMA polymerized emulsion, according to one or more embodiments of the present disclosure.

FIGS. 9A-9H are TEM and SEM images of SBMA and S-SBMA polymerized emulsion, according to one or more embodiments of the present disclosure.

FIGS. 10A-10C are images of antibacterial tests of SBMA and S-SBMA polymerized emulsion, according to one or more embodiments of the present disclosure.

### DETAILED DESCRIPTION

The present disclosure is directed to methods, systems, and compositions of elemental sulfur-acrylic emulsion. The compositions of elemental sulfur-acrylic emulsion described herein have vast ranges of industrial and academic applications, including paints and coatings, cosmetics and personal care, photonic crystals, chromatographic columns, electrochemical cells, agrochemicals, and biomedical devices. As compared to suspension and dispersion polymerization systems, emulsion polymerization offers the fastest polymerization rate and yields the highest molecular weight polymers. Furthermore, the methods of the present disclosure can be easily developed and industrialized due to the single pot, single stage synthesis process, the use of inexpensive monomer compounds, and ease of quality control.

Emulsion polymerization produces high molecular weight colloidal polymers and negligible volatile organic compounds (VOC). The reaction medium is usually water which facilitates agitation and mass transfer, and provides an inherently safe process. Moreover, the process is environmentally friendly. Emulsion polymerization procedures offer a method for polymerizing water-insoluble or slightly soluble monomers to high molecular weight polymers at rapid rates of polymerization. In emulsion polymerization procedures, this is achieved by using an oil-in water emulsifier (usually of the micelle-forming type) to form a large number of monomer particles, dispersed in an aqueous phase and a water-soluble initiator to generate free radicals in the aqueous phase. The free radicals diffuse through the aqueous phase and are captured by the monomer to grow the polymer particles. After capture, each free radical initiates a polymer chain in the particle which continues to grow until the entry of a second free radical. Hence, a high molecular weight polymer can be prepared at a rapid polymerization rate.

The polymerization is divided into three distinct stages, nucleation of particle nuclei by capture of radicals by monomer-swollen micelles, growth of latex particles by recruiting monomer and surfactant from the emulsified monomer droplets, and depletion of residual monomer in latex particles.

Embodiments of the disclosure also discuss the improved antibacterial properties of the copolymerization elemental sulfur with acrylic monomers. The elemental sulfur and acrylic monomers are readily accessible and offer an unexpected and novel polymerization mechanism to form sulfur emulsion.

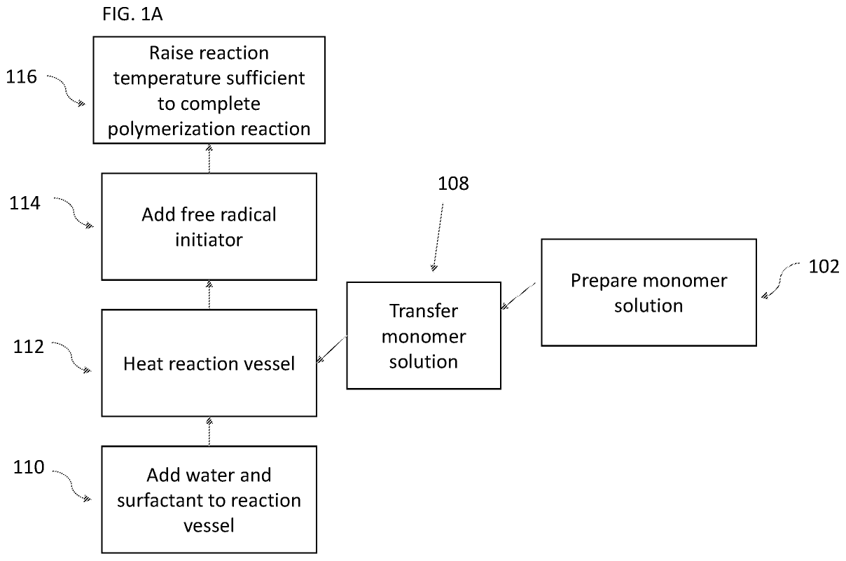

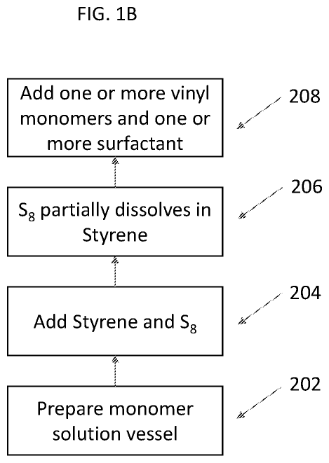

FIG. 1A is a block diagram of an elemental sulfur-acrylic emulsion process, according to one or more embodiments of the present disclosure. A monomer solution is prepared 102. The solution is transferred 108 to a reaction vessel, and water and additional or second surfactant added 110 (first surfactants utilized in monomer solution, see FIG. 1B). The vessel may then be heated 112 and one more free radical initiator added 114. The temperature of the reaction vessel may then be raised 116 for a time sufficient to complete the polymerization reaction.

In some embodiments, the monomer solution 102 comprises one or more vinyl monomers, S₈, and one or more surfactants. Examples of vinyl monomers includes styrene (STY), n-butyl methyl acrylate (BMA), methyl methacrylate (MMA), and acrylic acid (AA). However, in some embodiments the monomers are selected from a group consisting of pure acrylics, styrene acrylics, vinyl acrylics, acrylated ethylene vinyl acetate copolymers, and mixtures thereof. In one example, the vinyl monomers include BMA:MMA:Acrylic Acid:Styrene in a ratio of 1:1:1.4:8.35. In another example, the ratio is about 1:1:1.375:8.75. The amount or ratios of monomers can be defined in comparison to the sulfur content, for example. The monomers can be present by grams in a ratio to sulfur of about 35:1 (monomers by weight to sulfur by weight), about 30:1, about 20:1, about 15:1, about 10:1, about 9:1, for example. The ratio of monomers by weight to sulfur can range from about 6:1 to about 40:1, in an example.

The monomer solution comprises elemental sulfur present in an amount of 1 wt % to 10 wt %, based on the dry weight of the group of vinyl monomers. Alternatively, the sulfur may be present about 0.5% to 3%, about 1% to 5%, about 3% to 7%, about 4% to 10%, or about 0.5% to about 12%, for example. The sulfur content can be increased about 12% for example, depending on the choice of solvent to increase solubility of the sulfur.

An anionic surfactant can undergo dissociation when being dissolved in water with the part of surface activity exhibiting hydrophobic anion effects. Typical anionic surfactants include soaps, alkylbenzene sulfonates, alkyl sulfonates, alkyl sulfonates, alkyl sulfates, salts of fluorinated fatty acids, silicones, fatty alcohol sulfates, polyoxyethylene fatty alcohol ether sulfates, α-olefin sulfonate, polyoxyethylene fatty alcohol phosphates ether, alkyl alcohol amide, alkyl sulfonic acid acetamide, alkyl succinate sulfonate salts, amino alcohol alkylbenzene sulfonates, naphthenates, alkylphenol sulfonate and polyoxyethylene monolaurate. In one example, the anionic surfactant is sodium dodecyl sulfate (SDS). In solution, non-ionic surfactants are electrically neutral. Some examples include ethoxylates, alkoxylates, and cocamides. In some embodiments, the nonionic surfactant is an octylphenol ethoxylate, such as Triton X-114 and the anionic surfactant is sodium dodecyl sulfate (SDS). In some examples, the surfactant is added in a ratio to the total vinyl monomer composition (by weight) of about 0.09:1, or about 10% of the weight of the vinyl monomers. If both an anionic and nonionic surfactant are utilized, they can be added at a ratio of about 1:1 or about 1.1:1, or about 1.2:1, for example. In order to emulsify the acrylic-sulfur monomer phase into the water phase, an emulsifying agent or surfactant is used in amount ranging between 0.5 to 10 percent by weight of the acrylic-sulfur monomer.

FIG. 1B is a block diagram for a preparation of a monomer solution 102, according to one or more embodiments of the present disclosure. A monomer solution vessel is prepared 202. In some embodiments, the monomer solution vessel is temperature controlled and is equipped with stirring and/or mixing components to agitate the compounds. STY and S₈ are added 204 to the monomer solution vessel. S₈ is partially soluble 206 in Styrene after a few minutes. In some embodiments, the sulfur and Styrene are left in the monomer solution vessel for 1-10 minutes, heated, and/or agitated. One or more additional vinyl monomers, such as BMA, AA, and MMA are added 208 to the monomer solution vessel. In some embodiments, the STY, S₈, BMA, AA, and MMA are agitated for 5-20 minutes. One or more first surfactants, such as a nonionic surfactant(s) and anionic surfactant(s) are added to the monomer solution vessel 208.

The monomer solution is transferred 108 into the reaction vessel, which contains water and second surfactants (step 110). In some embodiments, a feed rate of the monomer solution is controlled such that the transfer takes 20-30 minutes.

The reaction vessel temperature is raised 112, and the reaction vessel is optionally agitated. In some embodiments, the reaction vessel temperature is raised to between 150-200° C. and the reaction vessel is stirred above 500 rpm throughout the reaction. A free radical initiator 114 is added to the reaction vessel. In some embodiments, the free radical initiator is potassium persulphate (KPS). Categories of initiators include one or more of anionic, cationic, photo, and radical initiators, for example. The addition of the free radical initiator initiates the polymerization reaction. The raising of temperature in the reaction vessel 112 can be done simultaneously with adding the free radical initiator 114, before step 114 or after step 114, for example.

In some embodiments, the reaction vessel temperature and reaction vessel agitation rate are maintained for a period of 6 hours. In some embodiments, polymerization is complete 116 when no separate layer of water or oil was visible.

A polymerization reaction is carried out in a single pot (i.e., the reaction vessel). In some embodiments, the reaction vessel is temperature controlled and is equipped with stirring and/or mixing components to agitate the compounds. Water and a nonionic surfactant are added to the reaction vessel 110. A reaction vessel temperature between 40-99° C. is maintained.

In some embodiments, the polymerization reaction occurs within a single pot, and in a single stage. Or in other words, once the polymerization reaction begins, no additional compounds are added or removed from the pot, and there are no significant changes in the reaction vessel temperature or the reaction vessel agitation rate.

The single pot, single stage in situ polymerization of monomers (STY, BMA, MMA, AA, S) formed a core-shell structure. The core structure is made of block copolymers of STY-BMA-AA, and the shell structure comprises MMA-AA. Sulfur is dispersed within the core-shell structure. The final product may be spherical or ellipsoid in nature, for example.

The following Examples are intended to illustrate the above invention and should not be construed as to narrow its scope. It should be understood that numerous variations and modifications may be made while remaining within the scope of the invention.

### Example 1

Various samples of sulfur-containing styrene acrylates (S-SBMA) emulsions were synthesized. The various samples were synthesized using different amounts of sulfur, from 0%, 3%, 5%, and 10% weight with respect to the other monomers. The various samples of S-SBMA then underwent an extensive characterization process.

The monomers styrene (STY), n-butyl methyl acrylate (BMA), methyl methacrylate (MMA), acrylic acid (AA), and elemental sulfur (S₈) were purchased from Sigma Aldrich. The monomers were distilled under vacuum to remove traces of inhibitor and stored at 5° C. before use. The free radical initiator, potassium persulphate (KPS, K2S2O8), was obtained from Sigma Aldrich with purity greater than 99%. Anionic surfactant Sodium dodecyl sulfate (SDS) and nonionic surfactant Triton X-114 were used as received from Sigma Aldrich. Deionized water (DW) was used throughout the synthesis process that purified by filtration through a milli-Q system.

Polymerization was carried out in a 100 ml three-necked round bottom flask (RBF) equipped with a magnetic beat, a reflux condenser, a nitrogen gas balloon, and an adjustable inlet funnel to feed monomer solutions. RBF was placed in an oil bath for controlling the temperature and the stirring speed was maintained at 550 rpm throughout the reaction. The reaction begins with (70 ml) distilled water, (0.05 g) SDS, and (0.05 g) Triton X-114 that loaded in RBF (Sol A). The reaction temperature was initially kept at 75° C. for 30 min.

In a different vessel (a 25 ml single neck round, bottom flask), a monomer solution was prepared (Sol B). The monomer solution starts with the addition of styrene and sulfur, as sulfur is partially soluble in styrene after a couple of minutes. BMA, AA, and MMA were added with respect to their proportion as the recipes are given in Table 1 for the various samples synthesized. The stirring speed was approximately 850-1000 rpm for uniform mixing of all monomers. After 15 minutes, both types of surfactants: SDS, 0.05 g and Triton X-114, 0.05 g, were mixed with the monomer solution. The monomer solution was transferred through the funnel that is attached in 3 necked RBF (Sol C). It is important to note that controlling the feed rate of monomer solution is important and should take 20-25 minutes for complete feeding.

Free radical initiator (KPS) 0.06 g is dissolved in 2 ml DW to initiate the reaction. The temperature reaction is slowly raised to 175° C. for 6 hours. The polymerization reaction occurred in a single vessel and in a single stage.

After the polymerization was complete, no separate layer of oil and water was visible after different intervals. However, milky white homogenous emulsion obtained also sulfur was completely encapsulated with other monomers polymeric chain that was confirmed by no sulfur particles seen in an emulsion. The resultant product cooled to room temperature and stored in weighted drying glass bottles. The various samples were synthesized by using different amounts of sulfur from 0%, 3%, 5%, and 10% with respect to other monomers whose concentration was constant throughout the reaction. The emulsion was poured into a Teflon petri dish to get as film after drying in a hot oven at 120° C. for further characterization.

TABLE 1
Chemical proportions of the various samples

| Sample, | Water | Styrene | AA | BMA | Sulfur | KPS | SDS | MMA | Triton |
|---|---|---|---|---|---|---|---|---|---|
| Wt % | (g) | (g) | (g) | (g) | (g) | (g) | (g) | (g) | (g) |
| SBMA | 75 | 3.55 | 0.60 | 0.425 | 0.00 | 0.06 | 0.25 | 0.425 | 0.20 |
| 3S-SBMA | 75 | 3.50 | 0.55 | 0.400 | 0.15 | 0.06 | 0.25 | 0.400 | 0.20 |
| 5S-SMBA | 75 | 3.42 | 0.54 | 0.391 | 0.25 | 0.06 | 0.25 | 0.391 | 0.20 |
| 10S-SBMA | 75 | 3.24 | 0.51 | 0.371 | 0.50 | 0.06 | 0.25 | 0.371 | 0.20 |

The one-pot in situ polymerization of all monomers (STY, BMA, MMA, AA, S) in a single stage formed a core-shell structure. The emulsion was stable for 12 months after the synthesis date when stored at room temperature. No adverse effect visualized in colors with no flocculation of particles appeared. After conducting various characterizations on the synthesized samples, it was confirmed that elemental sulfur becomes part of the Styrene/BMA/MMA/AA copolymer chain.

The synthesized samples were characterized by the following techniques. Fourier transformed infrared (FTIR) spectrum was determined through the KBr pellet method with a resolution of 4 cm-1 in the region of 4000 cm-1 to 500 cm-1 by using Fourier infrared spectrometer (Bruker Vertex 70). XRD of the samples was recorded using an analytical X Pert PRO powder diffractometer Cu Kα radiation 1.5406 Å, 45 kV, 40 mA) in the range of 5-60° 20 scale, with a step size of 0.02°. The surface morphology of the samples was characterized by scanning electron microscope by SEM, Quanta—FEG-250, and transmission electron microscope (TEM). TEM images were obtained using FEI Technai G20 operated at 200 kV accelerating voltage to observe the nanoscale structure of the sulfur in SBMA polymerized emulsion matrix. The emulsion samples were further diluted with DDI, and then diluted droplets were transferred onto copper grids, and dried in air. Differential Scanning calorimetry (DSC) analysis of the samples was done using DSC Netzsch at a heating rate of 10° C./min in the temperature range between-50 and 200° C. in a nitrogen environment. The thermal degradation behavior was studied in TGA Netzsch. The sample (8-13 mg) were scanned from 25 to 700° C. at a heating rate of 10° C./min in a nitrogen environment. The particle size and its distribution of the emulsions were determined by dynamic light scattering (DLS, Malvern Zetasizer Nano-ZS). Samples were diluted in distilled water till a transparent solution was obtained and then analyzed by DLS Analysis. The mean particle size was characterized by Z-average diameter (Dz) and the particle size distribution was characterized by polydispersity index (PDI) together with the curve of particle size distribution. The microscopic morphology of emulsion microspheres was observed using an optical microscope. An electrical conductivity probe (manufactured by Thermo Fischer Scientific in. Beverly, MA, USA) was used to measure electrical conductivity.

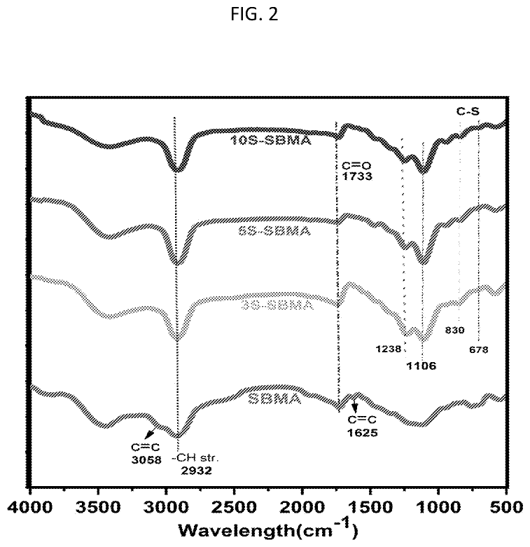

The interactions between sulfur and SBMA chains disclosed by FTIR spectra of SBMA and S-SBMA polymerized emulsion in the range of 4000-500 cm-1 displayed in FIG. 2. As illustrated in the FTIR spectra of SBMA, peaks associated with (2932, 1460 cm-1) C—H asymmetric stretching and bending vibration in methylene (CH2 group), methyl (CH3), (1735 cm-1) stretching vibration of the carbonyl ester C═O, the intense band at (3058, 1625 cm-1) attributed to olefinic linkages of C═C stretching vibration, (775,702 cm-1) ascribed to single substituted phenyl rings available in styrene moieties. As the sulfur is incorporated in reaction the peak height decrease for styrene unit indicates the addition of sulfur in monomer units. The FTIR spectra of S-SBMA confirmed the dispersion of sulfur unit linkages with other monomers by supplementary peaks around 678, 830 and 1106 cm-1 with other above-mentioned peaks that attribute due to C—S bonding signify successful chemical reaction.

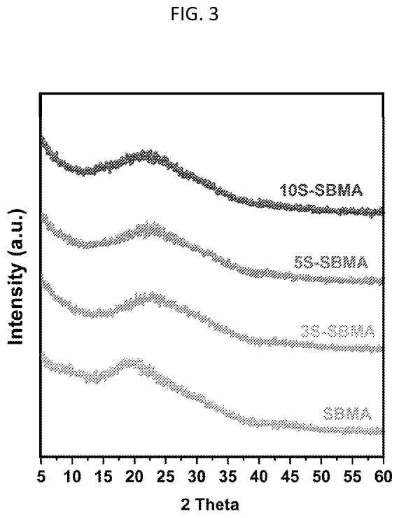

The crystalline nature of elemental sulfur changed into an amorphous structure after the emulsion polymerization with other monomers during emulsion polymerization. To confirm this, a study was carried out by comparing XRD results of elemental sulfur and sulfur incorporated emulsion samples. Diffraction patterns for elemental sulfur, SBMA, and S-SBMA emulsion samples in the range of 5°-60° are shown in FIG. 3. The diffraction pattern of pure sulfur exhibit high-intensity sharp peaks located at 23.4°, 25.7°, 26.4°, 27.5°, 28.4°, and 31.6°, indicating a highly crystallized orthorhombic sulfur (S8) structure. The broad hump between 14° and 25° resulted from the amorphous structure of SBMA polymerized emulsion. Comparing with S-SBMA emulsions with elemental sulfur, these crystalline peaks of sulfur completely disappeared in all polymerized samples indicates the allover exfoliation of sulfur during polymerization with other monomers without any aggregation observed.

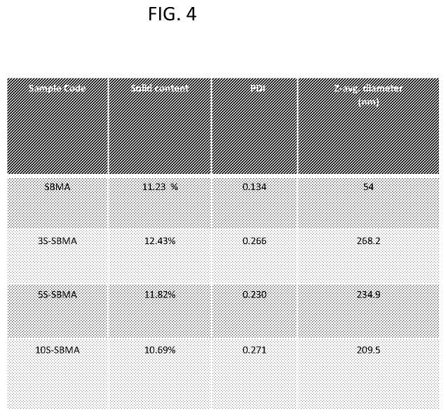

The parameter which most strongly signifies emulsion stability is particle size. Typically, an emulsion is said to be stable when particles are uniformly distributed on the boundary. The DLS chart of all synthesized samples was shown in FIG. 4. The average diameter of the SBMA sample was calculated to be 54 nm. On the contrary, after the inclusion of elemental sulfur along with other monomers the average dimeter of particles in emulsion increased to 268.2 nm. This result is likely due to the dispersion of sulfur atoms agglomerates after the covalent bonding with hydrophobic monomers (as used here: styrene and butyl methacrylate), so particle size of sulfur-based styrene acrylate emulsions increased. But as sulfur amount increased from 3% to 10%, this strong covalent bonding distressed the normal flow and obstruct the mobility of chain segments that causes particle size reduced from 268.2 nm to 209.5 nm with polydispersity index PDI<0.3 which is the requirement for dispersion homogeneity.

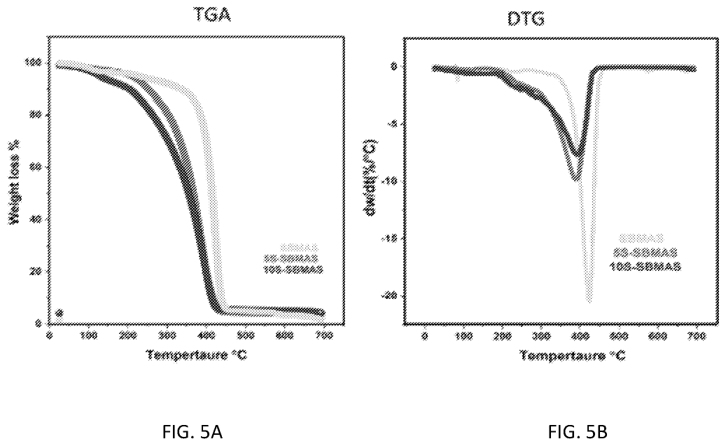

The thermal stability of the S-SBMA emulsion with various S-monomer contents are investigated by using TGA and DSC demonstrated in FIGS. 5A-5B. The TGA thermograph (FIG. 5A) shows that the thermal stability of SBMA emulsion displays a stable situation up to 200° C. It exhibits one-step decomposition that begins around 320° C. and completely decomposed around 430° C. However, thermal stability decreases at a temperature below 250° C. as elemental S-monomer amount increase, which may be ascribed to the lower stability of carbon-sulfur bonds as initial degradation of elemental sulfur starts at 190° C. and onset degradation domain around 260° C. However, when the temperature is more than 430° C., the thermal stability and char residue of the emulsion increase as sulfur amount increase. In DTG curve (FIG. 5B) sulfur (5% and 10% by wt.) incorporated SBMA samples show two-step thermal degradation. When the S content is 10 wt. % in SBMA sample, the char residue of the emulsion improves from 1.56% to 5.6% at 700° C. This signifies that after degradation of all polymeric species, polymerized sulfur exists inside the matrix in residue form. This residue not only prevent heat transmission or diffusion whereas reducing the heat release rate.

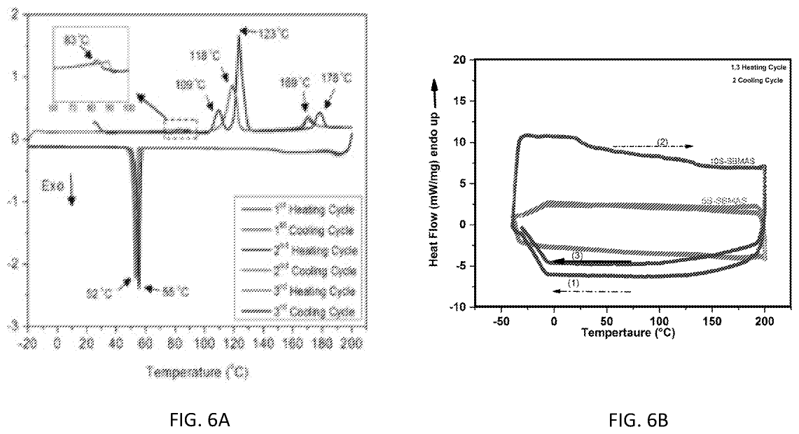

DSC thermogram of all polymerized emulsion and elemental sulfur are shown in FIGS. 6A-6B. In the DSC of elemental sulfur, the three endothermic transition displays at 105.5° C., 125° C., and at 184° C. attributes to the solid-solid transition of elemental sulfur from orthorhombic to monoclinic form, the melting of monoclinic sulfur, and the polymerization of sulfur. These melt transition peaks were completely absent in S-SBMA emulsion, which shows that the crystalline sulfur has been transformed to the amorphous form along with polymerized with chains of other polymerized monomers. This result further supports the results of the XRD (FIG. 3), where the formation of amorphous sulfur and no crystalline peaks displayed.

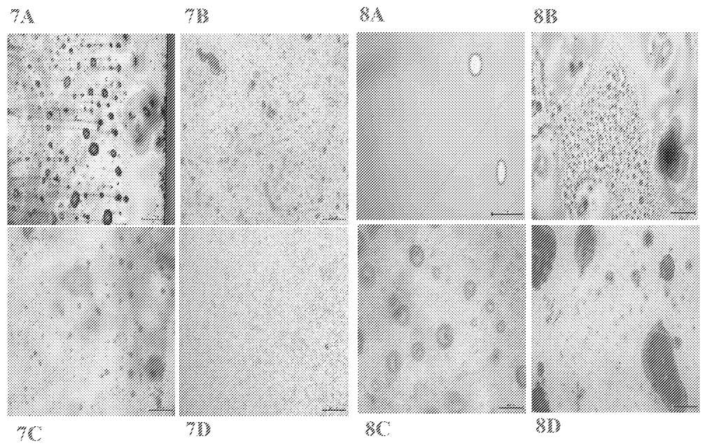

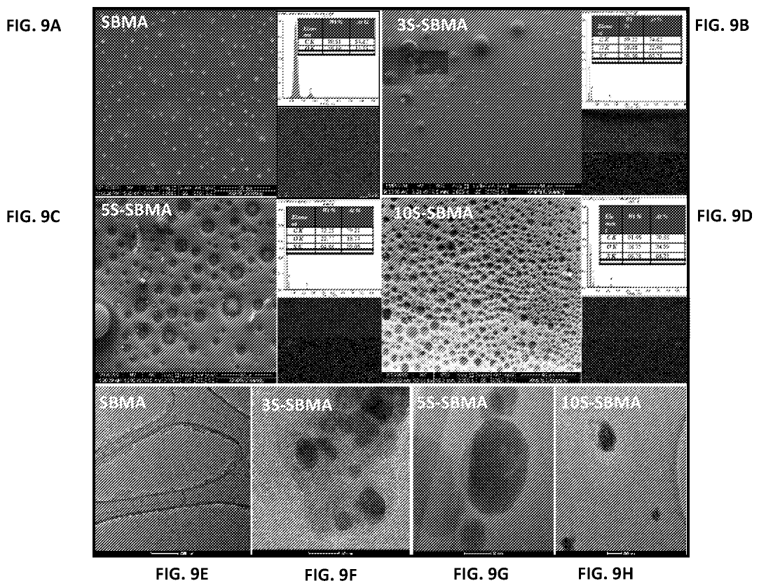

The optical microscope images of latex particles of SBMA samples that contain 0%, 3%, 5%, and 10% sulfur are shown in FIGS. 7A-D, and FIGS. 8A-8D, where two types of sample preparation are done. In one-way samples (FIGS. 7A-7D), droplet spread over glass slide and sample placed for drying in an oven at 120° C. for 24 hours. In the second-way samples (FIGS. 8A-8D) the drop of sample is applied directly on a glass slide and observed under an optical microscope. There was no need for further dilution as the sample had less solid content. The test results were as summarized: the optical images of samples taken by both methods shown all particles were approximately round in shape signifies core-shell structure that further support with SEM and TEM results. According to these images, SBMA latex has a low particle size as compared to sulfur contain samples, and by increasing the sulfur concentration, the particle size further decreases. SBMA emulsion has considerable porosity on their surface as compared to S containing samples. After reaction with elemental sulfur, this porosity cover-up by sulfur molecules as these sulfur molecules entrapped with hydrophobic monomers. Moreover, the morphology of the 10S-SBMA sample did not show any aggregation of sulfur particles, which indicates that sulfur has better dispersion compatibility with styrene and acrylate monomers. Therefore, these results show the addition of sulfur with styrene and acrylate monomers in the synthesis of latex particles was completed.

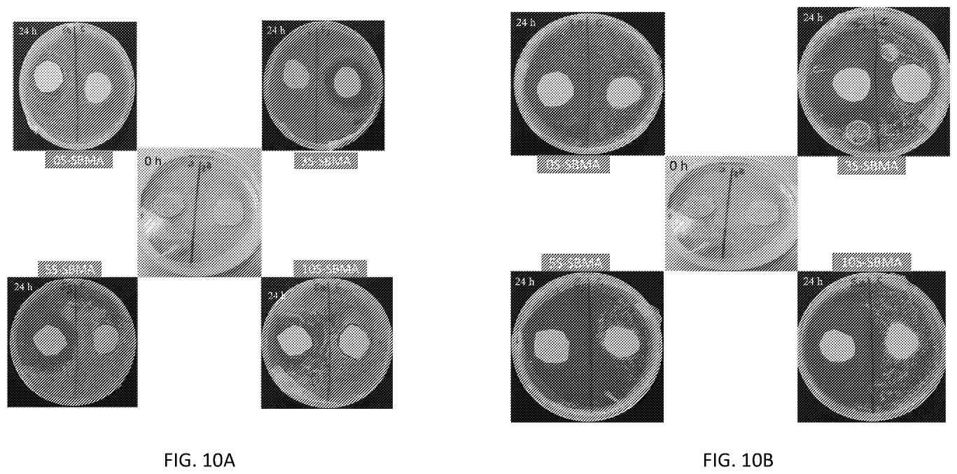

The surface morphology and dispersion of inorganic particles in the polymeric matrix were investigated by using SEM and TEM techniques. Therefore, SEM and TEM micrographs of SBMA, 3S-SBMA, 5S-SBMA, and 10S-SBMA latex particles were acquired and demonstrated in FIGS. 9A-9H. It was depicted in FIGS. 9B-9D of SEM analysis the white color spots in core-shell structure refer to the dispersion of sulfur depend on concentration, whereas FIG. 9A did not show any white color patches in core-shell morphology. As the loading content of S increased, large white spots were observed. The in situ polymerization process makes S particles be encapsulated due to steric hindrance caused by SBMA polymer long chain along with chemical bonding between all hydrophobic monomers led to interfacial compatibility among inorganic and polymeric phases.

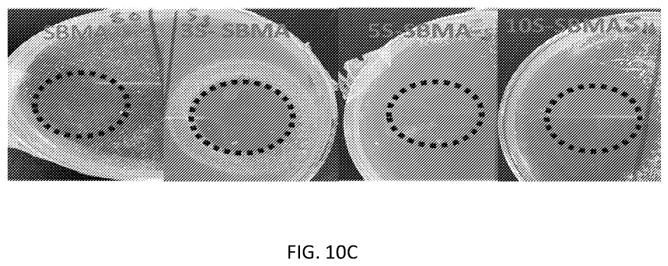

The antibacterial test was performed against E. Coli (FIG. 10B) and S. aureous (FIG. 10A) according to the agar disk diffusion method. The bacterial strains S. aureous and E. Coli were precultured in liquid broth for 24 hours at 37° C. in shaker incubator. 100 μL of microbial suspensions were spread by sterile cotton swab on agar plates, the autoclaved sterile filter paper discs of 8 mm, were impregnated in emulsion of different sulfur concentration and placed on nutrient agar plate. All plates were then incubated for 24 hr at 37° C. The inhibition zone was clearly shown in picture that as sulfur amount increased in emulsion both bacterial stains attached on samples were killed and cleared inhibition zone shown in FIGS. 10A-10B. FIG. 10C further shows complete inhibition of bacterial growth beneath.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A method of sulfur polymerization comprising:
preparing a monomer solution, the monomer solution comprising:
sulfur;
at least one monomer selected from a vinyl-monomer group comprising styrene, n-butyl methyl acrylate, methyl methacrylate, acrylic acid, and mixtures thereof;
one or more surfactants; and
preparing a reaction solution, the reaction solution comprising water;
combining the monomer solution with the reaction solution;
agitating the reaction solution and the monomer solution;
adding a free radical initiator; and
increasing a reaction temperature.

2. The method of claim 1, wherein the sulfur is present in an amount of 1 wt % to 10 wt % based on the dry weight of the at least one monomer.

3. The method of claim 1, wherein the one or more first surfactants comprise one or more of an anionic and nonionic surfactant.

4. The method of claim 1, wherein the one or more surfactants comprise at least sodium dodecyl sulfate (SDS).

5. The method of claim 1, wherein the reaction solution further comprises a nonionic surfactant.

6. The method of claim 1, wherein preparing the monomer solution further comprises stirring the monomer solution.

7. The method of claim 1, wherein a minimum stir rate of 500 rpm was maintained throughout the method.

8. The method of claim 1, wherein combining the monomer solution with the reaction solution further comprises controlling a feed rate.

9. The method of claim 1, wherein the method of sulfur polymerization is accomplished within a single reaction vessel.

10. The method of claim 1, wherein the method of sulfur polymerization is accomplished in a single reaction stage.

12. The method of claim 1, wherein the at least one vinyl monomer comprises styrene, n-butyl methyl acrylate, methyl methacrylate, and acrylic acid.

13. The method of claim 1, wherein the free radical initiator comprises potassium persulphate.

14. The method of claim 1, wherein raising the reaction temperature comprises raising the temperature between 150-200° C.

15. A polymeric composition comprising:
sulfur; and
at least one emulsion monomer selected from a group comprising styrene, n-butyl methyl acrylate, methyl methacrylate, acrylic acid, and mixtures thereof,
wherein the sulfur is dispersed in a core-shell structure of the at least one emulsion monomer.

16. The polymeric composition of claim 15, wherein the monomer comprises a mixture of styrene, n-butyl methyl acrylate, methyl methacrylate, and acrylic acid.

17. The polymeric composition of claim 15, wherein the sulfur present is about 1 wt % to 10 wt % based on the dry weight of the at least one emulsion monomer.
